(19) United States
(12) Patent Application Publication
(10) Pub. No.: US 2023/0256460 A1
(43) Pub. Date: Aug. 17, 2023

(54) ADAPTER FOR CONNECTING A FLUID RESERVOIR CAN TO A FLUID APPLICATOR

(71) Applicant: PPG Industries Ohio, Inc., Cleveland, OH (US)

(72) Inventor: Zachary Thomas Pellarin, Matthews, NC (US)

(73) Assignee: PPG Industries Ohio, Inc., Cleveland, OH (US)

(21) Appl. No.: 18/004,184

(22) PCT Filed: Jul. 6, 2021
(86) PCT No.: PCT/US2021/040432

§ 371 Date: Jan. 4, 2023

Related U.S. Application Data
(60) Provisional application No. 63/048,423, filed on Jul. 6, 2020.

(51) Int. Cl. B05B 7/24

(52) U.S. Cl. CPC B05B 7/2408; B05B 7/2478

(57) ABSTRACT

An adapter for communicating a fluid from a fluid reservoir can to a fluid applicator is disclosed. The adapter includes an inlet port, an outlet port, and a tapering central section. The inlet port includes an internally-threaded hollow cylindrical structure. The outlet port includes an externally-threaded hollow cylindrical structure coupled to and in fluid communication with the inlet port. An internal diameter of the inlet port is larger than an internal diameter of the outlet port. The tapering central section fluidly couples the internal diameter of the inlet port to the internal diameter of the outlet port and creates a fluid flow path there between. The inlet port is adapted to be fluidly coupled to an externally-threaded cap of the fluid reservoir can and the outlet port is adapted to be fluidly coupled to an internally-threaded fluid intake port of the fluid applicator.

### CROSS-REFERENCE TO RELATED APPLICATION

The present disclosure claims the benefit of priority of co-pending U.S. Provisional Patent Application 63/048,423, filed on Jul. 6, 2020, and entitled “ADAPTER FOR CONNECTING A FLUID RESERVOIR CAN TO A FLUID APPLICATOR,” the contents of which are incorporated in full by reference herein.

### TECHNICAL FIELD

The present disclosure generally relates to fluid applicators, such as pneumatic or compressed air spray guns, for delivering a fluid to a surface of a substrate. More particularly, the present disclosure relates to systems and methods for connecting a fluid reservoir can to a fluid applicator via an adapter.

### BACKGROUND

Fluid applicators, such as pneumatic or compressed air spray guns conventionally draw fluids (for example, preferred basecoats, primers, and/or paints) from open reservoir cups and deliver the fluids using compressed air to a surface of a substrate. The fluids are mixed in the open reservoir cups prior to attaching the reservoir cups to the fluid applicators. The fluid applicator can be a gravity fed fluid applicator, such that the fluid is delivered to the fluid applicator from the reservoir cup positioned above the fluid applicator using the force of gravity. Gravity fed fluid applicators are often preferred over other types of fluid applicators since they can operate at high volumes while the air supplied is under low pressure.

The fluid applicator receives pressurized air from an air compressor or the like and the fluid is atomized by the pressurized air as the pressurized air leaves the fluid tip of the fluid applicator, which delivers the atomized fluid to the surface of the substrate to coat or paint the substrate with the fluid.

The use of open reservoir cups for mixing the fluids can be problematic. First, reservoir cups are typically not re-used and are costly. Thus, the use of reservoir cups results in unnecessary cost and produces waste. Further, any fluid remaining after the fluid application to the surface of the substrate is complete is often discarded, resulting in further waste. The materials in the fluid can be considered hazardous and are not easily disposable. Thus, the left over fluid, the original container holding the fluid prior to mixing the fluid in the reservoir cup, and the reservoir cup itself all need to be properly disposed of, which can add further operational costs.

Thus, what is still needed in the art is an improved approach for providing fluids, such as paints and other coatings, to gravity fed pneumatic or compressed air spray guns, without the need for costly and wasteful open reservoir cups for applying the fluids to the surface of a substrate.

### SUMMARY

The present disclosure provides an adapter for communicating a fluid from a fluid reservoir can to a fluid applicator is disclosed. The adapter includes an inlet port, an outlet port, and a tapering central section. The inlet port includes an internally-threaded hollow cylindrical structure. The outlet port includes an externally-threaded hollow cylindrical structure coupled to and in fluid communication with the inlet port. An internal diameter of the inlet port is larger than an internal diameter of the outlet port. The tapering central section fluidly couples the internal diameter of the inlet port to the internal diameter of the outlet port and creates a fluid flow path there between. The inlet port is adapted to be fluidly coupled to an externally-threaded cap of the fluid reservoir can and the outlet port is adapted to be fluidly coupled to an internally-threaded fluid intake port of the fluid applicator.

The present disclosure also provides a fluid applicator adapted to deliver a fluid to a surface of a substrate. The fluid applicator includes an applicator gun, a fluid reservoir can, and an adapter. The applicator gun defines an internally-threaded fluid intake port. The fluid reservoir can comprises an externally-threaded can. The adapter is disposed between the applicator gun and the fluid reservoir can. The adapter includes an inlet port, an outlet port, and a tapering central section. The inlet port comprises an internally-threaded hollow cylindrical structure. The outlet port comprises an externally-threaded hollow cylindrical structure coupled to and in fluid communication with the inlet port. An internal diameter of the inlet port is larger than an internal diameter of the outlet port. The tapering central section fluidly couples the internal diameter of the inlet port to the internal diameter of the outlet port and creates a fluid flow path there between. The inlet port is adapted to be fluidly coupled to the externally-threaded cap of the fluid reservoir can and the outlet port is adapted to be fluidly coupled to the internally-threaded fluid intake port of the applicator gun.

The present disclosure further provides a fluid reservoir can. The fluid reservoir can includes an externally-threaded cap, a vent hole, and a stopper. The vent hole is formed in a bottom of the fluid reservoir cap opposite the externally-threaded cap. The stopper is adapted to be inserted into the vent hole. The stopper is adapted to plug the vent hole and block fluids from passing therethrough.

The present disclosure yet further provides a method for using a fluid applicator adapted to deliver a fluid to a surface of a substrate. The method includes providing an applicator gun defining an internally-threaded fluid intake port. The method also includes providing a fluid reservoir can comprising an externally-threaded can. The method further includes fluidly coupling the fluid reservoir can to the applicator gun by disposing an adapter between the applicator gun and the fluid reservoir can. The adapter includes an inlet port, an outlet port, and a tapering central section. The inlet port comprises an internally-threaded hollow cylindrical structure. The outlet port comprises an externally-threaded hollow cylindrical structure coupled to and in fluid communication with the inlet port. An internal diameter of the inlet port is larger than an internal diameter of the outlet port. The tapering central section fluidly couples the internal diameter of the inlet port to the internal diameter of the outlet port and creates a fluid flow path there between. The inlet port is adapted to be fluidly coupled to the externally-threaded cap of the fluid reservoir can and the outlet port is adapted to be fluidly coupled to the internally-threaded fluid intake port of the applicator gun.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a perspective diagram of a fluid applicator assembly;

FIG. 2 is a perspective diagram of the adapter of FIG. 1;

FIG. 3 is a perspective diagram of a side view of the adapter of FIG. 2;

FIG. 4 is a cross-sectional diagram of the adapter of FIG. 2;

FIG. 5 is a cross-sectional diagram of the adapter of FIG. 2 including a fluid filter;

FIG. 6 is a cross-sectional diagram of the adapter of FIG. 2 including a fluid filter;

FIG. 7 is a cross-sectional diagram of the adapter of FIG. 2 including a fluid filter;

FIG. 8 is a perspective diagram of a side view of the fluid reservoir can of FIG. 1;

FIG. 9 is a perspective diagram of a fluid reservoir can highlighting a vent hole formed therein;

FIG. 10 is a cross-sectional diagram of the stopper of FIG. 9;

FIG. 11 is a perspective diagram of the fluid reservoir can of FIG. 9 highlighting a seal positioned over the vent hole; and

FIG. 12 is a flowchart of a method for applying a fluid with the fluid applicator assembly.

### DETAILED DESCRIPTION

The present disclosure relates to systems and methods for connecting a closed fluid reservoir can to a fluid applicator via an adapter by fluidly coupling an internally-threaded inlet port of the adapter to an externally-threaded cap of the closed fluid reservoir can and fluidly coupling an externally-threaded outlet port of the adapter to an internally-threaded fluid intake port of the fluid applicator. By connecting the closed fluid reservoir can to the fluid applicator via the adapter, the closed fluid reservoir can, rather than an open reservoir cup, can be used to supply fluid, for coating a surface of a substrate, to the fluid applicator.

The fluid can be premixed to a desired color, viscosity, etc. by a supplier of the fluid in the closed fluid reservoir can. By supplying the fluid directly from the closed fluid reservoir can via the adapter to the fluid applicator, the extra expense of open reservoir cups can be avoided, and the mess resulting from mixing the fluid in the open reservoir cups can also be avoided. Further, since the fluid can be premixed, mixing errors by and operator can also be prevented.

After applying the fluid to a surface via the fluid applicator, the fluid reservoir can may be removed from the fluid applicator and any unused fluid can be preserved within the fluid reservoir can and used at a later time. A cap or a seal can be included with the fluid reservoir can that is reapplied to a top of the fluid reservoir can. Thus, by preserving the fluid in the fluid reservoir can, waste of any excess fluid can be avoided and costs for disposal of such excess fluids can also be avoided. Furthermore, as reservoir cups are no longer needed, further waste in disposing of the reservoir cups can also be avoided.

Imperfections in the fluid can clog the fluid applicator or result in imperfections in the coating of the fluid applied to the surface. Thus, the adapter optionally includes a filter therein, which acts to filter such imperfections to prevent clogging and to ensure uniform application of the fluid to the surface.

To assist the flow of the fluid out of the fluid reservoir can and to the fluid applicator via the adapter, a vent hole is formed in a bottom of the fluid reservoir can, opposite the externally-threaded cap at a top of the fluid reservoir can. A stopper with a vent opening and a plug can be inserted into the vent hole such that the vent opening allows fluid to flow therethrough while unblocked by the stopper and the vent opening is blocked from fluid flowing therethrough when the plug is inserted into the vent opening.

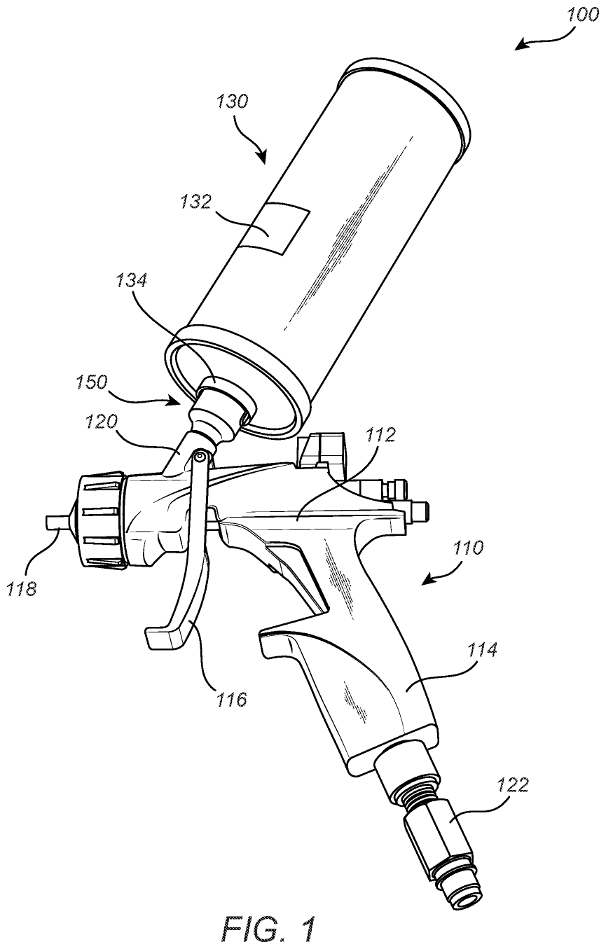

FIG. 1 is a perspective diagram of the fluid applicator assembly 100 of the present disclosure. As can be seen in FIG. 1, the fluid applicator assembly 100 generally includes a fluid applicator 110, an adapter 150, and a fluid reservoir can 130. The fluid applicator 110 can be an applicator gun, such as a pneumatic or compressed spray gun, well known to those of ordinary skill in the art. The fluid applicator 110 can include an applicator body 112, a handle 114, a trigger 116, a fluid tip 118, and an internally-threaded fluid intake port 120. A source of compressed air 122 (or another gas) can be connected to the handle 114. The adapter 150 can be connected to the fluid applicator 110 at the internally-threaded fluid intake port 120 and to the fluid reservoir can 130 at an externally-threaded cap 134, via threading.

When the trigger 116 is pulled, pressurized air can be fed to the applicator body 112 from the source of air 122, such as from an air compressor, and fluid from the fluid reservoir can 130 held in the reservoir portion 132 can be fed, via gravity, out of the externally-threaded cap 134 through the adapter 150 and into the fluid applicator 110 via the internally-threaded fluid intake port 120. The fluid can atomize in the pressurized air as the fluid and air flow out of the fluid tip 118 and can be propelled by the pressurized air towards a surface to apply the fluid to the surface. The fluid can be preferred basecoats, primers, paints, and the like.

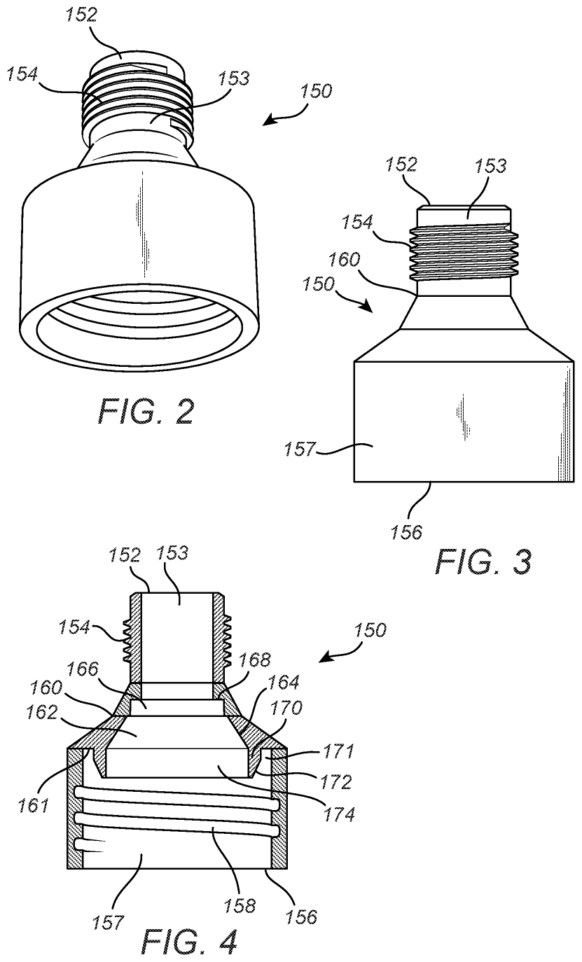

FIG. 2 is a perspective diagram of the adapter 150 of FIG. 1. FIG. 3 is a side view of the adapter 150 of FIG. 2. FIG. 4 is a cross-sectional diagram of the adapter 150 of FIG. 2. Referring collectively to FIGS. 2-4, the adapter 150 includes an outlet port 153 at an outlet end 152 of the adapter 150, an inlet port 157 at an inlet end 156 of the adapter 150, and a tapering central section 160 positioned therebetween fluidly coupling an internal diameter of the inlet port 157 to an internal diameter of the outlet port 153 and creating a fluid flow path therebetween.

The outlet port 153 and the inlet port 157 can each be a hollow cylinder, such as a right hollow cylinder. The adapter 150 includes outlet threading 154 positioned at an outer surface of the outlet port 153, such that the outlet port 153 includes an externally-threaded hollow cylindrical structure, and inlet threading 158 positioned at an internal surface of the inlet port 157, such that the inlet port 157 includes an internally-threaded hollow cylindrical structure. Each of the outlet threading 154 and the inlet threading 158 can be standard threading, specialized threading, proprietary threading, or the like.

Referring again to FIG. 1, the outlet port 153 can be received into the internally-threaded fluid intake port 120 and secured to the fluid applicator 110 by mating the externally-threaded hollow cylindrical structure, including the outlet threading 154, to the internally-threaded fluid intake port 120 and thereby fluidly coupling the outlet port 153 to the to the internally-threaded intake port 120 of the fluid applicator 110. The inlet port 157 can receive the externally-threaded cap 134 therein and can secure the fluid reservoir can 130 to the adapter 150 by mating the internally-threaded hollow cylindrical structure of the inlet port 157, including the inlet threading 158, to the externally-threaded cap 134 and thereby fluidly coupling the inlet port 157 to the externally-threaded cap 134 of the fluid reservoir can 130.

Referring to FIG. 4, the inlet port 157 has an internal diameter and an internal cross-sectional area that are larger than an internal diameter and an internal cross-sectional area, respectively, of the outlet port 153. The tapering central section 160 fluidly couples the internal diameter of the inlet port 157 to the internal diameter of the outlet port 153 and create a fluid flow path there between. The tapering central section 160 can include an internal bore 162 that includes one or more sections for reducing the cross-sectional area of the fluid path. The internal bore 162 of the tapering central section 160 can include a relatively larger internal diameter adjacent to the inlet port 157 and a relatively smaller internal diameter adjacent to the outlet port 153.

As shown in FIG. 4, the internal bore 162 of the tapering central section 160 can include a tapering bore 164 and can include a counterbore 166. The tapering bore 164 defines an internal surface with an internal diameter that reduces from an inlet end of the tapering bore 164 proximal to the inlet port 157 to an outlet end of the tapering bore 164 proximal to the outlet port 153. The tapering bore 164 can be a countersink with a frustoconical surface that reduces the cross-sectional area of the fluid path.

The counterbore 166 can be proximal to the outlet port 153 and can have an internal diameter that is larger than an internal diameter of the outlet port 153 such that a seating shelf 168 is defined at a bottom of the internal bore 162 within the tapering central section 160. The seating shelf 168 can have the shape of an annulus and can be a flat bottom of the counterbore 166. The counterbore 166 can be positioned axially between the tapering bore 162 and the outlet port 153. The internal diameter of the counterbore 166 can also be smaller than the internal diameter of the inlet port 157 and can be smaller than or match the internal diameter of the outlet end of the tapering bore 164.

The tapering central section 160 can define an annular sealing shelf 161 within the annular space 171 defined between the annular sealing lip 170 and the internally-threaded hollow cylindrical structure of the inlet port 157. The annular sealing shelf 161 can be adapted to contact the top annular edge 135 of the externally-threaded cap 134 of the fluid reservoir can 130. As mentioned above, the tapering bore 164 can taper from a larger internal diameter at an inlet end of the tapering bore 164 to a smaller diameter at an inlet end of the tapering bore 164. The internal diameter of the tapering bore 164 at the inlet end can be smaller than an interior diameter of the inlet port 157 such that the annular sealing shelf 161 is defined therebetween. The annular sealing shelf 161 can adjoin the inlet port 157 and can have a shape of an annulus. The annulus can be sized such that a diameter of a top annular edge 135 (refer to FIG. 8) of the externally-threaded cap 134 falls within the outer and inner diameters of the annulus. The externally-threaded cap 134 can be mated to the internally-threaded hollow structure of the inlet port 157 such that the top annular edge 135 of the externally-threaded cap 134 forms a seal with the annular sealing shelf 161.

The adapter 150 also includes an annular sealing lip 170. The annular sealing lip 170 extends from the tapering central section into the inlet port 157. The annular sealing lip 170 can be a hollow cylinder with a seal passage 174 that has an internal diameter that matches or is similar to the internal diameter of the tapering bore 164 at the inlet end. The annular sealing lip 170 can be coaxial to the inlet port 157 such that the annular sealing lip 170 is disposed concentrically within and coaxial with the inner bore of the inlet port 157. The annular sealing lip 170 and the internally-threaded hollow cylindrical structure of the inlet port 157 can define an annular space 171 there between. The annular space 171 can be adapted to receive a top annular edge 135 of the externally-threaded cap 134 of the fluid reservoir can 130. The annular sealing lip 170 can be sized to be insert into the externally-threaded cap 134 within the top annular edge 135. The annular sealing lip 170 can be adapted to form an interference fit with the externally-threaded cap 134 to form a seal and prevent the fluid from leaking between the inlet port 157 and the externally-threaded cap 134. In particular, an external diameter of the annular sealing lip 170 can be larger than an internal diameter of the externally-threaded cap 134 at the top annular edge 135 so that, upon mating, a seal is formed at the interface between the annular sealing lip 170 and the externally-threaded cap 134. The annular sealing lip 170 can include a tapered end 172 that is distal to the annular sealing shelf 161. The tapered end 172 can be a chamfer at an outer distal edge of the annular sealing lip 170. The outer diameter at the outer distal end of the tapered end 172 can be smaller than the internal diameter of the externally-threaded cap 134 at the top annular edge and gradually increase to the outer diameter of the annular sealing lip 170. The smaller outer diameter of the tapered end 172 at the outer distal end thereof can guide the annular sealing lip 170 into the internal diameter of the top annular edge 135 of the externally-threaded cap 134 to ensure proper mating between the annular sealing lip 170 and the externally-threaded cap 134, particularly when the annular sealing lip 170 and the externally-threaded cap 134 are configured with an interference fit.

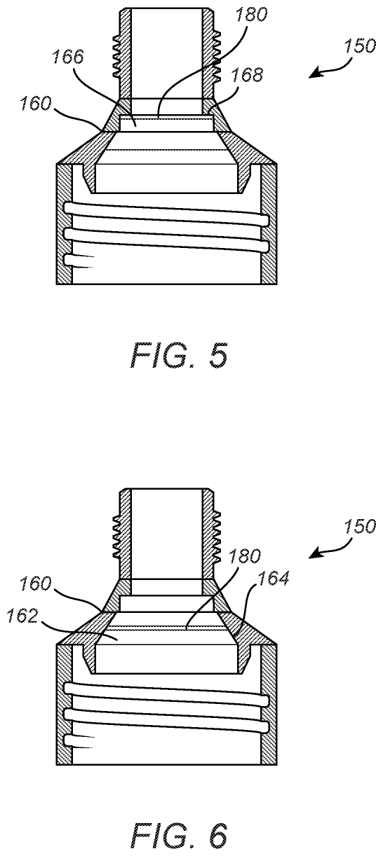

FIG. 5 is a cross-sectional diagram of the adapter 150 of FIG. 2 including a fluid filter 180. FIG. 6 is a cross-sectional diagram of the adapter 150 of FIG. 2 including a fluid filter 180. As can be seen in FIGS. 5 and 6, the adapter 150 can include a fluid filter 180. The fluid filter 180 can be positioned within the fluid path. The fluid filter 180 can include an annular wall and a filter element held within the annular wall. By way of non-limiting example, the filter element includes a mesh, such as a nylon mesh, and can allow the fluid to pass therethrough while preventing any impurities from passing through the adapter 150 and into the fluid applicator 110.

The fluid filter 180 can be disposed and secured within the internal bore 162 of the tapering central section 160, and in particular, can be disposed and secured within the counterbore 166 of the internal bore 162, as illustrated in FIG. 5, or can be disposed and secured within the tapering bore 164 of the internal bore 162, as illustrated in FIG. 6.

As disclosed above, the internal bore 162 of the tapering central section 160 can define a seating shelf 168. As illustrated in FIG. 5, the fluid filter 180 can be disposed on the seating shelf 168. The external diameter of the annular wall of the filter element 180 can be larger than the internal diameter of the internal bore 160, such that the fluid filter 180 and the forms an interference fit with the tapering central section 160 within the internal bore 162.

As illustrated in FIG. 6, the external diameter of the annular wall of the fluid filter 180 can be larger than the internal diameter of the outlet end of the tapering bore 164 and smaller than the internal diameter of the inlet end of the tapering bore 164 such that the fluid filter 180 is disposed axially between the outlet and inlet ends of the tapering bore 164.

The annular wall of the fluid filter 180 can include protrusions or depressions on an external surface thereof adapted to mate with corresponding protrusions or depressions formed at internal walls of the internal bore 162, such as at the internal circumferential walls of the counterbore 166 or at the internal circumferential walls of the tapering bore 164. Mating protrusions on at least one of the external surface of the annular wall of the fluid filter 180 and internal walls of the internal bore 162 with depressions on the other of the external surface of the annular wall of the fluid filter 180 and internal walls of the internal bore 162 can further secure the fluid filter 180 within the internal bore 162 of the tapering central section 160.

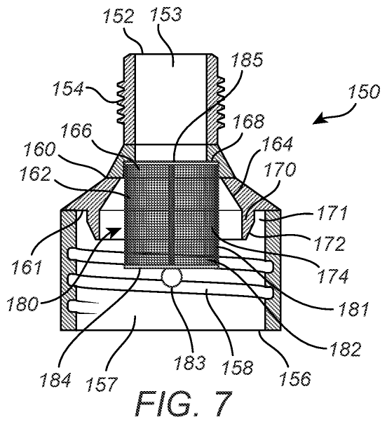

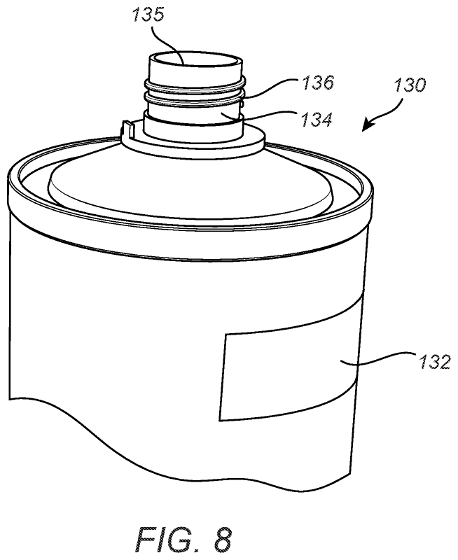

FIG. 7 is a cross-sectional diagram of the adapter of FIG. 2 including a fluid filter 180. By way of non-limiting example, the fluid filter 180 of FIG. 7 includes a hollow structure 181. The hollow structure 181 is at least partially defined by one or more filter elements 182. The filter elements 182 are positioned at the sides and at the top 184 of the hollow structure 181. The bottom 185 of the hollow structure 181 is open, without a filter element 182. The bottom 185 of the hollow structure is adapted to be seated within the counterbore 166 against the seating shelf 168. The bottom 185 of the hollow structure 181 is adapted to form an interference fit with the counterbore 166, such as with the internal circumferential wall of the counterbore 166. The hollow structure 181 is adapted to extend from the seating shelf 168 towards the inlet end 156. As such, fluid entering the inlet end 156 passes through the filter elements 182 in the side(s) and top 184 of the fluid filter 180 to filter out the impurities before passing into the inlet port 153.

In the non-limiting example illustrated in FIG. 7, the hollow structure 181 is a hollow right circular cylinder. The bottom 185 includes an annular shape defining an opening for the fluid to pass into the inlet port 153 after impurities from the fluid by the filter elements 182 in the cylindrical wall and the end 184 of the hollow right circular cylinder. The outer diameter of the annular shape of the bottom 185 is larger than the diameter of the internal circumferential wall of the counterbore 166 to define the interference fit therebetween. Other shapes, such as hollow prisms with a plurality of sides, are also contemplated.

In the non-limiting example illustrated in FIG. 7, the fluid filter 180 includes a nub 183 extending from the top 184 of the hollow structure 181. The nub 183 is adapted for gripping and handling the fluid filter 180, such as for seating and removing the fluid filter 180 into and from the inlet port 157, and in particular, from the counter bore 166.

FIG. 8 is a perspective diagram of a side view of the fluid reservoir can 130 of FIG. 1. As noted above, the fluid reservoir can 130 can include a reservoir portion 132 and an externally-threaded cap 134. The reservoir portion 132 can be a cylindrical container, such as a can, that is adapted to hold the fluid. The externally-threaded cap 134 can be adapted to allow the fluid to flow out of the reservoir portion 132. The externally-threaded cap 134 includes can threading 136 on an external surface, which can be threaded and mated to the inlet threading 158 of the adapter 150. A cover or a seal can be included with the fluid reservoir can 130. The cover or seal can include an internally-threaded structure that mates with the externally-threaded cap 134 to seal the fluid reservoir can 130 to preserve the fluid remaining within the reservoir portion 132 after the fluid reservoir can 130 is disconnected from the adapter 150.

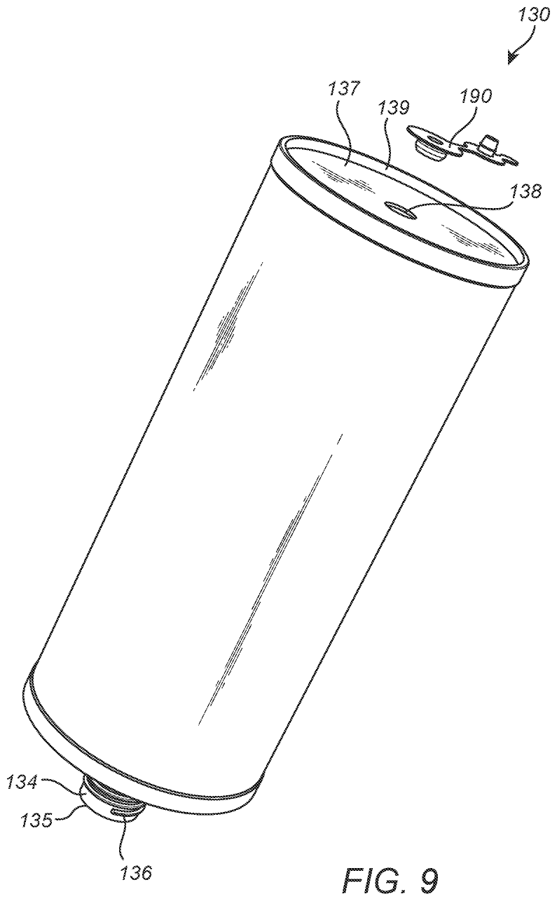

FIG. 9 is a perspective diagram of a fluid reservoir can 130 of FIG. 1 highlighting a vent hole 138 formed therein. In the non-limiting example of the fluid reservoir can 130 of FIG. 9, a vent hole 138 is formed in a bottom 137 of the fluid reservoir can 130. The vent hole 138 is adapted to allow fluid to pass therethrough, such that as the fluid stored in the fluid reservoir can 130 gravity fed out via the externally-threaded cap 134, fluid, such as air, enters the fluid reservoir can 130 via the vent hole 138.

The fluid reservoir can 130 includes an annular lip 139 that extends beyond the bottom 137, such that the bottom 137 is offset from an end of the fluid reservoir can 130 defined by the annular lip 139.

In the non-limiting example of FIG. 9, the fluid reservoir can 130 also includes a stopper 190 that is adapted to be inserted into the vent hole 138, to allow fluid to flow therethrough while in an unblocked configuration, and to blocked from fluid flowing therethrough while in a closed configuration.

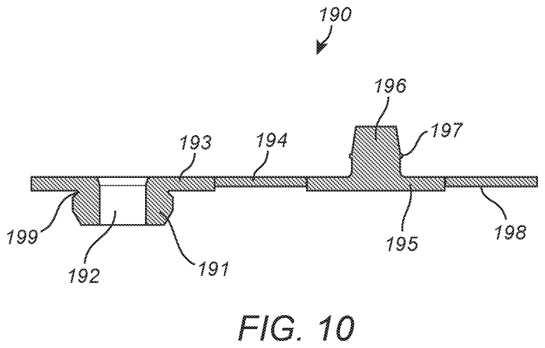

FIG. 10 is a cross-sectional diagram of the stopper 190 of FIG. 9. In the non-limiting example of FIG. 10, the stopper 190 includes a base portion 193 and a cap 195 joined via a connector 194. The connector 194 is flexible allowing the cap 195 to be brought into contact with the base portion 193. The base portion 193 is adapted to contact the bottom 137 of the fluid reservoir can 130. The base portion 193 includes a vent insert portion 191 extending from a body of the base portion 193. The vent insert portion 191 is adapted to be inserted into the fluid reservoir can 130 via the vent hole 138. The vent insert portion 191 tapers from an end thereof to expand a thickness thereof (such as a diameter) at a central position between the end of the vent insert portion 191 and the body of the base portion 193 and also tapers to reduce a thickness thereof from the central position to the body of the base portion 193. The vent insert portion 191 includes a bulbous shape. The end of the vent insert portion 191 includes a diameter smaller than a diameter of the vent hole, while a diameter of the central portion is larger than the diameter of the vent hole 138.

The body of base portion 193 and the vent insert portion 191 form an indent 199 at an interface thereof. The indent 199 is an annular channel. The indent 199 is adapted to receive the edge of the bottom 137 that defines the vent hole 138 to secure the stopper 190 to the bottom of the fluid reservoir can 130.

The base portion 193 also includes a vent opening 192 formed therein. The vent opening 192 extends through the base portion 193 including extending through the vent insert portion 191. The vent opening 192 is adapted allow fluid to flow therethrough, such that fluid can flow therethrough while the vent opening 192 is in an unblocked condition. The vent opening 192 includes a bevel at the top thereof, the top being the end distal to the vent insert portion 191.

The cap 195 includes a plug 196 adapted to be inserted into the vent opening 192. The plug 196 includes a tapered end that is narrower at the end to facilitate the insertion of the plug 196 into the vent opening 192. The plug 196 is adapted to form an interference fit with the vent opening 192 to secure the plug 196 therein. The plug 196 includes a protrusion 197 that protrudes from a remainder of the plug 196 and that is adapted to form the interference fit with the vent opening 192. The remainder of the plug 196 is sized smaller than the vent opening 192, while the protrusion 197 is sized larger than the vent opening 192 to form the interference fit. While the plug 196 is secured in the vent hole 192, the stopper 190 is in a blocked configuration, which prevents fluids from entering or leaving the fluid reservoir can 130 through the vent opening 192.

The stopper 190 also includes a tab 198 extending from the cap 195. The tab 198 is adapted to facilitate the removal of the plug 196 from the vent hole 192, such as by providing material to be gripped and pulled allowing sufficient force to be applied to overcome the interference fit between the plug 196 and the vent hole 192.

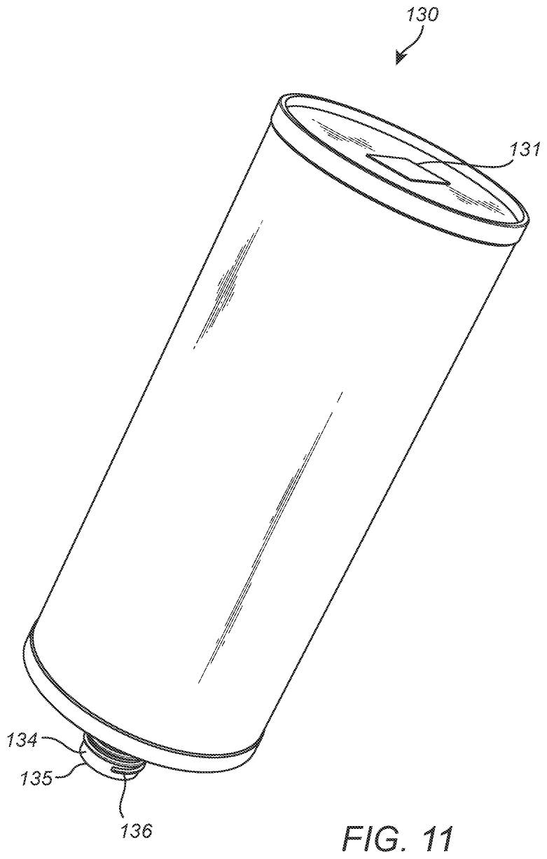

FIG. 11 is a perspective diagram of the fluid reservoir can 130 of FIG. 9 highlighting a seal 131 positioned over the vent hole 138. The fluid reservoir can 130 includes a seal 131 that is adapted to be removable therefrom. Various conditions during the manufacturing process and/or the distribution process could cause the stopper 190 to become dislodged or to not maintain a complete seal of the fluid reservoir can 130 at the vent hole 138. As such, by way of non-limiting example, the seal 131 is positioned over the vent hole 138 and is adapted to remain in place over the vent hole 138 during those various conditions and until the seal 131 is intentionally removed. By way of non-limiting example, the stopper 190 is secured with the fluid reservoir can 130, such as being attached thereto or positioned within a cap of the fluid reservoir can 130, during the distribution thereof. Upon removal of the seal 131, the stopper 190 is secured in place over the vent hole 138, such as by inserting the vent insert portion 191 therein. Alternatively, the seal 131 is removed during use of the fluid reservoir can 130 and a new seal 131 is applied after the use thereof and for storage of the fluid reservoir can 130.

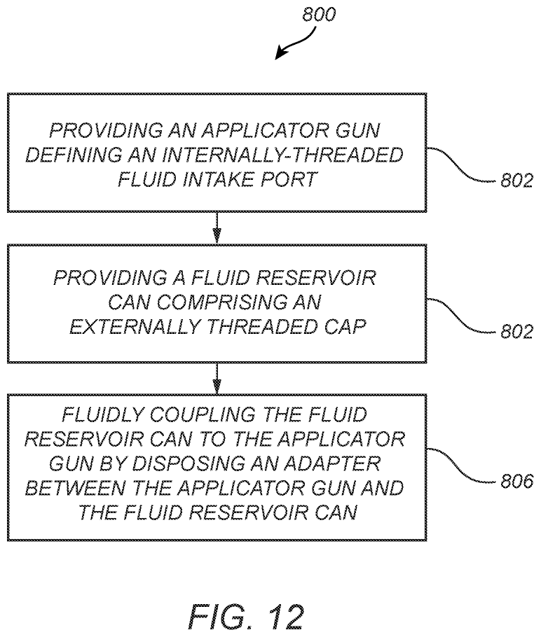

FIG. 12 is a flowchart of a method 800 for using a fluid applicator 110 adapted to deliver a fluid to a surface of a substrate. The method 800 can include providing an applicator gun defining an internally-threaded fluid intake port 120 at step 802. The applicator gun can be a fluid applicator 110.

The method 800 can also include providing a fluid reservoir can 120 comprising an externally-threaded cap 134 at step 804. The method can further include fluidly coupling the fluid reservoir can 120 to the applicator gun by disposing an adapter 150 between the applicator gun and the fluid reservoir can at step 806.

As described above in further detail, the applicator 150 disposed between the applicator gun and the fluid reservoir can can include: the an inlet port comprising the internally-threaded hollow cylindrical structure; the outlet port comprising the externally-threaded hollow cylindrical structure coupled to and in fluid communication with the inlet port, where the internal diameter of the inlet port is larger than an external diameter of the outlet port; and the tapering central section fluidly coupling the internal diameter of the inlet port to the internal diameter of the outlet port and creating the fluid flow path there between, wherein the inlet port is adapted to be fluidly coupled to the externally-threaded cap of the fluid reservoir can and the outlet port is adapted to be fluidly coupled to the internally-threaded fluid intake port of the fluid applicator.

As discussed above, a seal can be formed between the annular sealing lip 170 of the adapter 150 and the externally-threaded cap 134 and between the the annular sealing shelf 161 of the adapter 150 and the top annular edge 135 of the externally-threaded cap 134. These seals can prevent fluid from leaking out of the adapter 150 at the interface between the inlet port 153 of the adapter 150 and the externally-threaded cap 134 of the fluid reservoir can 120.

However, these seals can also prevent air from flowing into the fluid reservoir can 130 as the fluid flows out of the fluid reservoir can 130, which can inhibit the flow of the fluid out of the fluid reservoir can 130. As such, the applicator assembly 100 can include a vent, which facilitates the flow of air into the fluid reservoir can 130 as the fluid flows out of the fluid reservoir can 130. The vent can be formed in the adapter 150 in a position that allows air to enter the adapter 150 and flow into the fluid reservoir can 130, but without allowing fluid to leak therethrough.

As described above, the vent can also be formed in the fluid reservoir can 130, such as the vent hole 138 formed in the bottom of the fluid reservoir can 130 opposite the externally-threaded cap 134. A plug, such as the stopper 190, can also be supplied, which seals the vent formed in the fluid reservoir can 130 when the fluid reservoir can 130 is not in use with the fluid applicator 110. The plug can further include an opening therein with an integral cap, such that the opening acts as the vent and the integral cap plugs the opening when the fluid reservoir can 130 is not in use. When the plug includes the opening and the integral cap, the plug can be integral to and part of the fluid reservoir can 130.

Where the fluid reservoir can 130 includes the seal 131, the method can also include removing the seal 131 and inserting the plug, such as the stopper 190, into the vent hole 138. The method can further include removing the plug 196 from the vent opening 192 prior to applying the fluid to a surface and replacing the plug 196 into the vent opening 192 after applying the fluid to the surface.

Thus, the present disclosure provides to systems and methods for connecting a closed fluid reservoir can to a fluid applicator via an adapter by fluidly coupling an internally-threaded inlet port of the adapter to an externally-threaded cap of the closed fluid reservoir can and fluidly coupling an externally-threaded outlet port of the adapter to an internally-threaded fluid intake port of the fluid applicator. By connecting the closed fluid reservoir can to the fluid applicator via the adapter, the closed fluid reservoir can, rather than an open reservoir cup, can be used to supply fluid, for coating a surface of a substrate, to the fluid applicator.

The fluid can be premixed to a desired color, viscosity, etc. by a supplier of the fluid in the closed fluid reservoir can. By supplying the fluid directly from the closed fluid reservoir can via the adapter to the fluid applicator, the extra expense of open reservoir cups can be avoided, and the mess resulting from mixing the fluid in the open reservoir cups can also be avoided. Further, since the fluid can be premixed, mixing errors by and operator can also be prevented.

After applying the fluid to a surface via the fluid applicator, the fluid reservoir can may be removed from the fluid applicator and any unused fluid can be preserved within the fluid reservoir can and used at a later time. A cap or a seal can be included with the fluid reservoir can that is reapplied to a top of the fluid reservoir can. Thus, by preserving the fluid in the fluid reservoir can, waste of any excess fluid can be avoided and costs for disposal of such excess fluids can also be avoided. Furthermore, as reservoir cups are no longer needed, further waste in disposing of the reservoir cups can also be avoided.

Whereas the present disclosure has been illustrated and described herein with reference to specific examples thereof, it will be readily apparent to those of ordinary skill in the art that other examples may perform similar functions and/or achieve like results. All such equivalent examples are within the spirit and scope of the present disclosure, are contemplated thereby, and are intended to be covered by the following claims.

What is claimed is:

1. An adapter for communicating a fluid from a fluid reservoir can to a fluid applicator, the adapter comprising:
an inlet port comprising an internally-threaded hollow cylindrical structure;
an outlet port comprising an externally-threaded hollow cylindrical structure coupled to and in fluid communication with the inlet port, wherein an internal diameter of the inlet port is larger than an internal diameter of the outlet port; and
a tapering central section fluidly coupling the internal diameter of the inlet port to the internal diameter of the outlet port and creating a fluid flow path there between; and
wherein the inlet port is adapted to be fluidly coupled to an externally-threaded cap of the fluid reservoir can and the outlet port is adapted to be fluidly coupled to an internally-threaded fluid intake port of the fluid applicator.

2. The adapter of claim 1, wherein the tapering central section comprises an annular sealing lip that is disposed concentrically within and coaxial with an inner bore of the inlet port, the annular sealing lip and the internally-threaded hollow cylindrical structure of the inlet port defining an annular space there between that is adapted to receive a top annular edge of the externally-threaded cap of the fluid reservoir can.

3. The adapter of claim 2, wherein the tapering central section defines an annular sealing shelf within the annular space defined between the annular sealing lip and the internally-threaded hollow cylindrical structure of the inlet port that is adapted to contact the top annular edge of the externally-threaded cap of the fluid reservoir can.

4. The adapter of claim 1, further comprising a fluid filter disposed therein.

5. The adapter of claim 4, wherein the tapering central section includes a counterbore that defines a seating shelf, wherein the fluid filter includes a hollow structure that include at least one filter element, and wherein a bottom of the hollow structure is disposed on the seating shelf.

6. The adapter of claim 5, wherein the fluid filter further includes a bulb extending from a top of the hollow structure, opposite the bottom of the hollow structure, the bulb adapted to be gripped for handling the fluid filter.

7. The adapter of claim 1, wherein an internal bore of the tapering central section has a relatively larger internal diameter adjacent to the inlet port and a relatively smaller internal diameter adjacent to the outlet port.

8. A fluid applicator adapted to deliver a fluid to a surface of a substrate, the fluid applicator comprising:
an applicator gun defining an internally-threaded fluid intake port;
a fluid reservoir can comprising an externally-threaded cap;
an adapter disposed between the applicator gun and the fluid reservoir can, the adapter comprising:
an inlet port comprising an internally-threaded hollow cylindrical structure;
an outlet port comprising an externally-threaded hollow cylindrical structure coupled to and in fluid communication with the inlet port, wherein an internal diameter of the inlet port is larger than an internal diameter of the outlet port; and
a tapering central section fluidly coupling the internal diameter of the inlet port to the internal diameter of the outlet port and creating a fluid flow path there between; and
wherein the inlet port is adapted to be fluidly coupled to the externally-threaded cap of the fluid reservoir can and the outlet port is adapted to be fluidly coupled to the internally-threaded fluid intake port of the applicator gun.

9. The fluid applicator of claim 8, wherein the tapering central section of the adapter comprises an annular sealing lip that is disposed concentrically within and coaxial with an inner bore of the inlet port, the annular sealing lip and the internally-threaded hollow cylindrical structure of the inlet port defining an annular space there between that is adapted to receive a top annular edge of the externally-threaded cap of the fluid reservoir can.

10. The fluid applicator of claim 9, wherein the tapering central section of the adapter defines an annular sealing shelf within the annular space defined between the annular sealing lip and the internally-threaded hollow cylindrical structure of the inlet port that is adapted to contact the top annular edge of the externally-threaded cap of the fluid reservoir can.

11. The fluid applicator of claim 8, further comprising a fluid filter disposed and secured within the adapter.

12. The fluid applicator of claim 11, wherein the tapering central section includes a counterbore that defines a seating shelf, wherein the fluid filter includes a hollow structure that include at least one filter element, and wherein a bottom of the hollow structure is disposed on the seating shelf.

13. The fluid applicator of claim 12, wherein the fluid filter further includes a bulb extending from a top of the hollow structure, opposite the bottom of the hollow structure, the bulb adapted to be gripped for handling the fluid filter

14. The fluid applicator of claim 8, wherein an internal bore of the tapering central section of the adapter has a relatively larger internal diameter adjacent to the inlet port and a relatively smaller internal diameter adjacent to the outlet port.

15. The fluid applicator of claim 8, wherein the fluid reservoir can includes a vent hole formed in a bottom thereof opposite the externally-threaded cap.

16. The fluid applicator of claim 15, wherein the fluid reservoir can further includes a stopper inserted into the vent hole, the stopper adapted to plug the vent hole and block fluids from passing therethrough.

17. The fluid applicator of claim 16, wherein the stopper includes a base portion and a cap, wherein the base portion includes a vent opening formed therein and is adapted to be secured to the bottom of the fluid reservoir can at the vent hole, and wherein the cap includes a plug 196 that is adapted to be inserted into the vent opening to seal the vent opening.

18. A fluid reservoir can comprising:
an externally-threaded cap;
a vent hole formed in a bottom of the fluid reservoir cap opposite the externally-threaded cap; and
a stopper adapted to be inserted into the vent hole, the stopper adapted to plug the vent hole and block fluids from passing therethrough.

19. The fluid reservoir can of claim 18, wherein the stopper includes a base portion and a cap, wherein the base portion includes a vent opening formed therein and is adapted to be secured to the bottom of the fluid reservoir can at the vent hole, and wherein the cap includes a plug 196 that is adapted to be inserted into the vent opening to seal the vent opening.

20. The fluid reservoir can of claim 18, further comprising a seal secured over the vent hole, wherein the seal is removable, and wherein the seal is adapted to be removed prior to the stopper being inserted into the vent hole.
